(19) United States
(12) Patent Application Publication
(10) Pub. No.: US 2019/0095058 A1
(43) Pub. Date: Mar. 28, 2019

(54) DETERMINING A USER INTERFACE

(71) Applicant: Nicholas Velloff, Larkspur, CA (US)

(72) Inventor: Nicholas Velloff, Larkspur, CA (US)

(21) Appl. No.: 16/141,600

(22) Filed: Sep. 25, 2018

Related U.S. Application Data
(60) Provisional application No. 62/562,847, filed on Sep. 25, 2017.

(51) Int. Cl. G06F 3/0482; G06F 3/0484

(52) U.S. Cl. CPC G06F 3/0482; G06F 3/04847

(57) ABSTRACT

A non-transitory computer readable medium may be coupled to a processor and contain containing instructions executable to determine a type of user interface to be presented. Instructions may further be executable to determine a plurality of elements to be presented based on the determined type of user interface. Additional instructions may be executable to receive a first input for a first element of the plurality of elements, wherein the first input indicates that the first element is to remain part of a workflow, and to receive a second input for a second element of the plurality of elements, wherein the second input indicates that the second element is to be removed from the workflow. Further instructions may be executable to determine a permission for the first element and to determine whether the first element has a default value.

### PRIORITY

This applications claims priority to U.S. Provisional Patent Application No. 62/562,847, filed on Sep. 25, 2017, the contents of which are herein incorporated by reference.

### BACKGROUND

User interfaces may be used to assist a user in operation of a machine or device, such as a computing device. A user interface may allow a user to interact with the machine or device, allowing the user to accomplish a specific task or job. A particular user interface may allow a user to engage in multiple types of operations.

### BRIEF DESCRIPTION OF THE DRAWINGS

FIG. 1 is an example system for determining a user interface consistent with the present disclosure.

FIG. 2 is an example method for determining a user interface consistent with the present disclosure.

### DETAILED DESCRIPTION

User interfaces may be used as a connection point between a user and a machine or device, such as a computing device. The user interface may include a plurality of elements that, when presented to the user, allow the user to input values or information, specify instructions, and otherwise engage and interact with the device. In some examples, a particular user interface may include only elements that are pertinent to a particular workflow being undertaken; in other examples, the user interface may include all elements used by the device, regardless of whether a particular workflow uses some of the elements. As a result, a user may have to sift through and filter out unneeded elements in order to accomplish a particular task or workflow.

Moreover, when unnecessary and extraneous elements are presented to a user, the visual presentation of the user interface can appear crowded and overwhelming. A user may end up searching through multiple extraneous elements to find a particular element to engage with. This is inefficient and may add time to the overall workflow. In addition, having to interface with all elements, rather than the particular elements for a workflow, may increase the cognitive load placed on the user.

In addition, user interfaces often include elements that receive feedback and information from other elements. When extra elements are present, a user may inadvertently engage with an element that appears to be a necessary one but is actually not suited for the particular workflow. This can cause errors in feedback, and thus in future decisions made by the user based on workflow. Moreover, when the error is discovered, the user has to repeat his previous work using the correct element, adding additional time and cost to the workflow.

Determining a user interface according to the present disclosure, by contrast, allows a simplified user interface to be presented to a user. A determination may be made as to a type of workflow to be used. Based on the determined type of workflow, a plurality of elements may be determined to be pertinent to the type of workflow. The determined elements will be included on the user interface. A user, such as an administrator, is then able to provide further inputs for each element to further constrain and reduce the number of elements presented as part of the user interface. In addition, the presented elements may have permissions or default values specified.

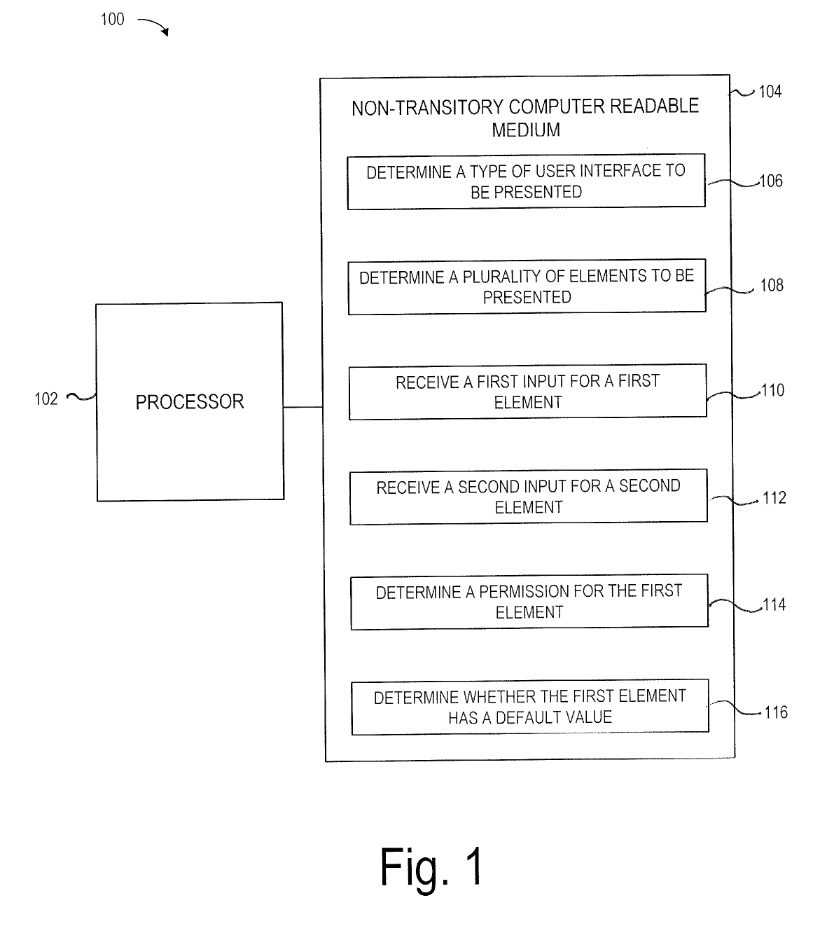

FIG. 1 is an example system 100 for determining a user interface consistent with the present disclosure. System 100 may be a computing device, although examples are not so limited. In the example of FIG. 1, system 100 includes a processor 102 and a non-transitory computer readable medium 104. Although the following descriptions refer to a single processor and a single non-transitory computer readable medium, the descriptions may also apply to a system with multiple processors and multiple computer readable storage mediums. In such examples, the instructions may be distributed (e.g., stored) across multiple computer readable storage mediums and the instructions may be distributed across or executed by multiple processors.

System 100 may include a processor 102. Processor 102 may be one or more central processing units (CPUs), microprocessors, and/or other hardware devices suitable for retrieval and execution of instructions stored in non-transitory computer readable storage medium 104. In the particular example shown in FIG. 1, processor 102 may retrieve, determine, and execute instructions 106, 108, 110, 112, 114, and 116 for determining a user interface. As an alternative, or in addition to retrieving and executing instructions, processor 102 may include one or more electronic circuits including a plurality of electronic components for performing the functionality of one or more of the instructions stored or contained within non-transitory computer readable medium 104.

Non-transitory computer readable medium 104 may be any electronic, magnetic, optical, or other physical storage device that stores executable instructions. Thus, non-transitory computer readable medium may be, for example, Random Access Memory (RAM), an Electrically-Erasable Programmable Read-Only Memory (EEPROM), a storage drive, an optical disk, or any similar non-transitory medium able to be read by a processor. Non-transitory computer readable medium 104 may be disposed within system 100, as shown in FIG. 1; in such examples, executable instructions may be “installed” within the system 100. Alternatively and/or additionally, non-transitory computer readable medium 104 may be a portable, remote, or external storage medium that, for example, allows system 100 to download the instructions from the medium. In such examples, the executable instructions may be part of an installation package. As described herein, non-transitory computer readable medium 104 may be encoded with executable instructions for determining a user interface.

Instructions 106, when executed by a processor such as processor 102, may include instructions to determine a type of user interface to be presented. The type of user interface may correspond to a particular environment, such as a retail center or a manufacturing center, or may correspond to a particular user, such as a supervisor, an information technology (IT) professional, or a regular employee. In some examples, the type of user interface may be determined based on an identity of a user of the system 100. For example, an administrator interface may be presented when system 100 determines that a user with administrative privileges has logged onto system 100. In other examples, the user interface may be determined based on an input by the user. For instance, although an administrator may be using system 100, he may be doing so to design a user interface for a non-administrative employee; thus, the user interface may be one corresponding to the employee and not to the administrator.

Instructions 108, when executed by a processor such as processor 102, may include instructions to determine a plurality of elements to be present. As used herein, an element refers to a single portion of a larger user interface. An element may correspond to a particular input value or function that is a portion of the overall interface. Instructions 108 may include instructions executable to review all available elements and determine whether an individual element corresponds to the determined type of user interface. In some examples, elements may include tags indicating the types of user interfaces to which they correspond. For example, an element labeled “clothing” may be tagged to correspond to a retail user interface, while a “sale” element may be tagged to correspond to a retail user interface, a manufacturing user interface, and a services user interface. Examples are not so limited, however, and other methods for determining which elements correspond to a particular user interface may be used. In addition, instructions 108 may include instructions executable to present every element that corresponds to the determined user interface.

Instructions 110, when executed by a processor such as processor 102, may include instructions to receive a first input for a first element of the plurality of elements. The first element may be one of the elements determined by instructions 108 and presented as corresponding to the user interface determined by instructions 106. In some examples, the input received by instructions 110 may indicate that the element is to remain part of a workflow. That is, instructions 110 may receive a first input indicating that the first element is pertinent to the particular workflow being created on the user interface and thus should remain visible and present. For example, in a retail setting, a “sales tax” element may be desirable as part of the workflow; thus, a first input on the sales tax element may indicate that the element should remain. Examples are not so limited, however, and other types of elements may be determined to be desirable as part of the workflow. In addition, multiple elements may receive inputs similar to the first input; that is, multiple elements may be indicated as remaining as part of the workflow.

Instructions 112, when executed by a processor such as processor 102, may include instructions to receive a second input for a second element of the plurality of elements. As with instructions 110, the element may be one of the elements determined by instructions 108 and presented as corresponding to the user interface determined by instructions 106. In some examples, the input received by instructions 112 may indicate that the second element is to be removed from the workflow. Said differently, instructions 112 may receive a second input indicating that the second element is not pertinent to the particular workflow being created. In response, instructions 112 may remove the second element from the workflow. For example, in a particular retail setting, a “clothing” element may not be desirable as part of the workflow because the retail setting does not include selling clothes; second input, thus, may remove the clothing element from the workflow.

Instructions 112 may further include instructions executable to treat non-interaction with an element as the second input. For instance, a user may decide to not expressly input that a particular element or set of elements is not pertinent to a workflow and may instead only input elements that are to remain. Instructions 112 may include instructions executable to determine elements that were not interacted with by the user (i.e., did not receive inputs), and treat those elements as being non-desirable by hiding or removing them. Thus, a user may not have to individually input a status for each element, but may only input a status for elements that are to be kept as part of the workflow.

Instructions 114, when executed by a processor such as processor 102, may include instructions to determine a permission for the first element. As used herein, a permission refers to an access right for a particular file within a network or computing device. In some examples, instructions 114 may include instructions executable to determine that the first element is a read/write element. As used herein, a read/write element refers to an element that is able to be updated, erased, and otherwise altered by a user. Thus, when a first element is determined to be a read/write element, the first element is able to be changed or altered by the user of the workflow. In some examples, the user may be able to input a particular value into the element, such as a price, a measurement, or a text. However, examples are not so limited, and other types of updates may be performed on the first element.

Instructions 116, when executed by a processor such as processor 102, may include instructions to determine whether the first element has a default value. As used herein, a default value refers to a preselected or advance-set value. Instructions 116 may include instructions executable to determine that the first element includes a data field. The data field may correspond to a particular type of data, such as a price, measurement, or other value. Instructions 116 may further include instructions executable to determine a type of default value.

Instructions 116 may include instructions executable to determine that the first element has a simple default value. As used herein, a simple default value refers to a pre-defined integer or string. The simple default value may automatically populate the data field of the first element. In some examples, the simple default value may be set by a user as part of the first input; that is, the simple default value may be input by a user when the first element is added to the workflow.

Instructions 116 may further include instructions executable to determine that the first element has a dynamic default value. As used herein, a dynamic default value refers to a value that is computed or otherwise determined based on other values. For example, a dynamic default value may be determined based on inputs to three other elements, although examples are not so limited. When the default value is determined to be dynamic, instructions 116 may include instructions executable to populate the data field with the determined default value based on the dependent values. In addition, instructions 116 may include instructions executable to update the dynamic default value when one or more of the dependent values is altered.

Instructions 116 may additionally include instructions executable to determine that the first element has a constrained default value. As used herein, a constrained default value refers to a value that has a defined minimum value and a defined maximum value. A user may input a value into the data field; however, the input value must be between the minimum and maximum values. For example, a minimum value may be set at two and a maximum value may be set at six; thus, any value between two and six may be input and be within the constrained default values. As with the dynamic default value, the minimum and/or maximum values for the constrained default value may be set as part of the first input, when the first element is added to the workflow.

System 100 may further include instructions executable by processor 102 to receive a third input for a third element of the plurality of elements. The third element may be one of the elements determined by instructions 108 and presented as corresponding to the user interface determined by instructions 106. In some examples, the third input may indicate that the third element is a read-only element. As used herein, a read-only element refers to an element that is displayed but is not able to be updated, erased, or otherwise altered. In some examples, the third element may be a descriptive element used for reference or may show a result obtained by combining inputs from other elements. However, examples are not so limited, and the third element may be any type of read-only element. The third element may remain part of the workflow and may include information for the user of the workflow; however, it may be an un-alterable piece of the workflow.

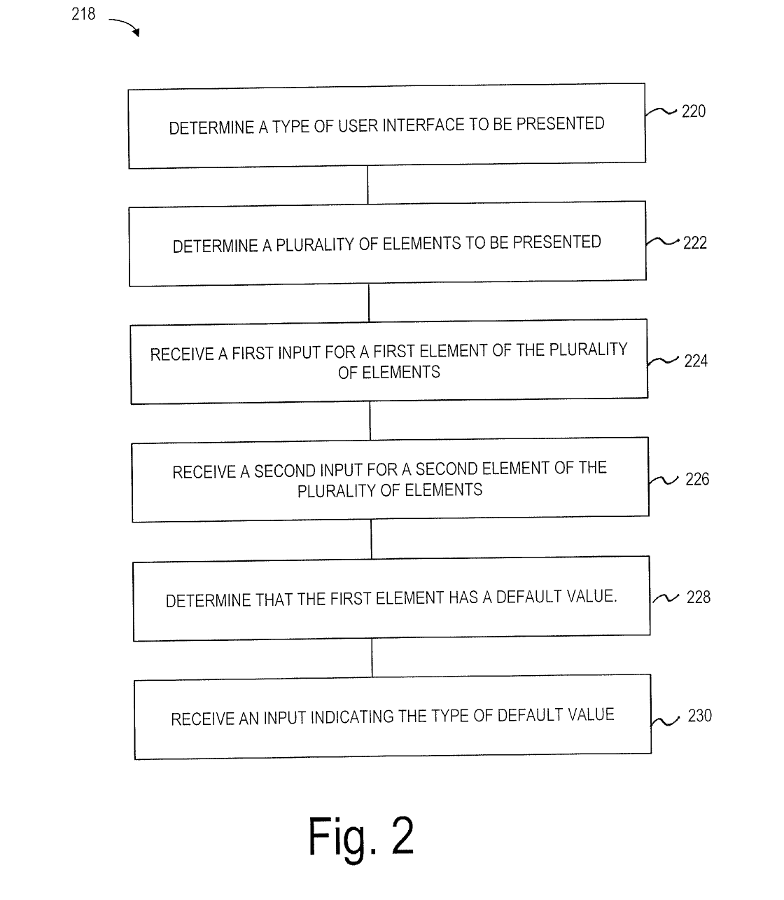

FIG. 2 is an example method 218 for determining a user interface consistent with the present disclosure. At 220, method 218 may include determining a type of user interface to be presented. The user interface to be presented may be determined based on, for example, a particular environment (e.g. retail, manufacturing), on a particular user (e.g. administrator, employee), or a combination. Of course, examples are not so limited, and the type of user interface to be presented may be determined based on other factors as well.

At 222, method 218 may include determining a plurality of elements to be presented. In some examples, the plurality of elements to be presented may be determined based on the type of user interface determined at 220. That is, the elements determined to be presented at 222 may correspond to the type of user interface determined at 220. In some examples, determining a plurality of elements to be presented may further comprise determining that an element of the plurality of elements includes a descriptor that corresponds to the type of user interface. For example, the user interface to be presented may be determined at 220 to be a retail user interface. At 222, an element may be determined to have a “retail” descriptor attached to it. Thus, the element may be selected to be presented based on the presence of the particular descriptor. By contrast, an element with a “manufacturing” descriptor may not be selected. Examples are not so limited, however, and elements may be determined to correspond to the determined type of user interface in other manners.

At 224, method 218 may include receiving a first input for a first element of the plurality of elements. The first element may correspond to an element determined at 222 to correspond to the type of user interface determined at 220. In some examples, receiving a first input for a first element at 224 may include receiving an input that the first element is to remain as part of a workflow. That is, receiving a first input at 224 may include indicating that the first element is desirable for display on the user interface.

Receiving a first input at 224 may further include receiving a permission level for the first element. In some examples, the first input may indicate that the first element is a read-only element. In such examples, the permission level of the first element may be adjusted to correspond to read-only functionality in response to receiving the first input. In other examples, the first input may indicate that the first element is a read/write element. In such examples, the permission level may be adjusted to correspond to read/write functionality in response to receiving the first input.

At 226, method 218 may include receiving a second input for a second element of the plurality of elements. In some examples, the second input may indicate that the second element is to be removed from the workflow; that is, the second input may indicate that the second element is not pertinent to the particular workflow and thus should not be included. In response, the second element may be hidden or otherwise removed from the user interface.

In some examples, the second input may correspond to a lack of interaction by a user. For example, a user may be presented with a plurality of elements as part of a user interface and may only desire to include a subset of the elements in a workflow. The user may indicate that the subset of elements are to remain as part of the workflow (such as in step 224) but may desire to not individually specify that the other elements are to be removed. In such examples, when the user completes the workflow, the elements that were not interacted with (i.e. specified as part of the workflow) may be considered as elements that should be hidden or removed.

At 228, method 218 may include determining that the first element has a default data value. As described with respect to FIG. 1, a default data value refers to a preselected or preset value. Determining that the first element has a default data value at 228 may include determining a type of element. For example, the first element may be a “sales tax” element; thus, determining that the first element is a sales tax element may include determining that the first element has a default value. Examples are not so limited, however, and any type of default value may be used and determined to exist as part of the first element.

At 230, method 218 may include receiving an input indicating the type of default value for the first element. In some examples, the input may be received at 230 in response to the first element being determined to have a default data value at 228. In other examples, the input may be received as part of the first input received at 224.

In some examples, receiving an input indicating the type of default value at 230 may include receiving an input that the default value is a simple default value. As described with respect to FIG. 1, a simple default value refers to a pre-defined integer and string. When the default value is a simple default value, receiving an input at 230 may further include receiving an input indicating the value corresponding to the simple default value.

In other examples, receiving an input indicating the type of default value at 230 may include receiving an input that the default value is a dynamic default value. As described with respect to FIG. 1, a dynamic default value is computed or otherwise determined based on other values. When an input that the default value is a dynamic default value is received, a determination may be made as to the basis upon which the dynamic default value is based may be made. For example, where the dynamic default value is “total money”, the basis for the dynamic default value may be “purchases”; however, examples are not so limited. Based on the determined basis, the dynamic default value may be populated or input.

In still other examples, receiving an input indicating the type of default value at 230 may include receiving an input that the default value is a constrained default value. As described with respect to FIG. 1, a constrained default value has a defined minimum and a defined maximum value. Thus, upon receipt of an input that the default value is a constrained default value, receiving an input at 230 may further include receiving an input indicating the minimum default value and the maximum default value, setting the constraints for the default value.

In the foregoing detailed description of the present disclosure, reference is made to the accompanying drawings that form a part hereof, and in which are shown by way of illustration how examples of the disclosure may be practiced. These examples are described in sufficient detail to enable those of ordinary skill in the art to practice the examples of this disclosure, and it is to be understood that other examples may be utilized and that process and/or structural changes may be made without departing from the scope of the present disclosure.

The figures herein follow a numbering convention in which the first digit corresponds to the drawing figure number and the remaining digits identify an element or component in the drawing. Elements shown in the various figures herein can be added, exchanged, and/or eliminated so as to provide a number of additional examples of the present disclosure. In addition, the proportion and relative scale of the elements provided in the figures are intended to illustrate the examples of the present disclosure and should not be taken in a limiting sense.

1. A non-transitory computer readable medium coupled to a processor containing instructions executable to:
determine a type of user interface to be presented;
determine, based on the determined type of user interface, a plurality of elements to be presented;
receive a first input for a first element of the plurality of elements, wherein the first input indicates that the first element is to remain part of a workflow;
receive a second input for a second element of the plurality of elements, wherein the second input indicates that the second element is to be removed from the workflow;
determine a permission for the first element; and
determine whether the first element has a default value.

2. The non-transitory computer readable medium of claim 1, further comprising instructions executable to receive a third input for a third element of the plurality of elements, wherein the third input indicates that the third element is a read-only element of the workflow.

3. The non-transitory computer readable medium of claim 1, wherein the instructions to determine a permission for the first element further comprise instructions executable to determine that the first element is a read/write element.

4. The non-transitory computer readable medium of claim 1, wherein the instructions to determine whether the first element has a default value include instructions executable to:
determine that the first element includes a data field; and
determine a type of default value.

5. The non-transitory computer readable medium of claim 4, wherein the instructions to determine a type of default value include instructions executable to determine that the first element has a simple default value.

6. The non-transitory computer readable medium of claim 4, wherein the instructions to determine a type of default value include instructions executable to determine that the first element has a dynamic default value.

7. The non-transitory computer readable medium of claim 4, wherein the instructions to determine a type of default value include instructions executable to determine that the first element has a constrained default value.

8. A method, comprising:
determining a type of user interface to be presented;
determining, based on the determined type of user interface, a plurality of elements to be presented, wherein the plurality of elements correspond to the type of user interface;
receiving a first input for a first element of the plurality of elements, wherein:
the first input indicates that the first element is to remain part of a workflow; and
the first input indicates a permission level for the first element;
receiving a second input for a second element of the plurality of elements, wherein the second input indicates that the second element is to be removed from the workflow;
determining that the first element has a default data value; and
receiving an input indicating the type of default value for the first element.

9. The method of claim 8, wherein determining a plurality of elements to be presented further comprises:
determining that an element of the plurality of elements includes a descriptor corresponding to the type of user interface; and
selecting the element.

10. The method of claim 8, wherein receiving a first input for the first element further comprises:
receiving an input that the first element is a read-only element; and
adjusting the permission of the first element to correspond to read-only functionality.

11. The method of claim 8, wherein receiving a first input for the first element further comprises:
receiving an input that the first element is a read/write element; and
adjusting the permission of the first element to correspond to read/write functionality.

12. The method of claim 8, wherein receiving an input indicating the type of default value for the first element further comprises:
receiving an input that the default value is a simple default; and
receiving an input indicating the value for the simple default.

13. The method of claim 8, wherein receiving an input indicating the type of default value for the first element further comprises:
receiving an input that the default value is a dynamic default;
determining a basis upon which the dynamic default is based; and
populating the default value based on the determined basis.

14. The method of claim 8, wherein receiving an input indicating the type of default value for the first element further comprises:
receiving an input that the default value is a constrained default;
receiving an input indicating a minimum default value; and
receiving an input indicating a maximum default value.
